(19) United States
(12) Patent Application Publication
(10) Pub. No.: US 2006/0282474 A1
(43) Pub. Date: Dec. 14, 2006

(54) Systems and methods for processing changing data

(76) Inventor: Allan Stuart MacKinnon JR., Boston, MA (US)

Correspondence Address: GOODWIN PROCTER LLP;PATENT ADMINISTRATOR, EXCHANGE PLACE, BOSTON, MA, 02109-2881, US

(21) Appl. No.: 11/334,036

(22) Filed: Jan. 18, 2006

Related U.S. Application Data
(60) Provisional application No. 60/644,659, filed on Jan. 18, 2005.

(51) Int. Cl. G06F 17/30

(52) U.S. Cl. 707/200

(57) ABSTRACT

Systems and methods for data processing using incremental algorithms. Embodiments of the invention decompose complex or monolithic data processing problems into one or more incremental computations called flows. These flows may be distributed across a networked cluster of commodity computers, facilitating the easy scaling of the system and robust recovery functionality. Once a request is submitted to the system, its solution may be maintained from that point in time forward, such that whenever changes are made to a problem's data the solution is efficiently recomputed.

### CROSS-REFERENCE TO RELATED APPLICATIONS

This application claims the benefit of U.S. Provisional Application No. 60/644,659, filed on Jan. 18, 2005, which is hereby incorporated by reference as if set forth in its entirety herein.

### FIELD OF THE INVENTION

The present invention relates generally to systems and methods for processing changing data, and more specifically to systems and methods for incremental data processing.

### BACKGROUND OF THE INVENTION

Database applications utilize ever-increasing flows of data, typically data changing in real-time. Existing general-purpose data processing systems, like relational databases, are neither designed nor equipped to process rapidly changing data. Instead, these systems typically stretch the paradigm of ad hoc interaction with a user or an application in an attempt to handle changing data.

FIG. 1 illustrates the operation of a typical relational database system 100. One or more users submit queries 104 to the system 100 for processing. The system parses 108 the query 104, creates a plan 112 for executing the query 104, and executes the plan 116 against the records 120 stored in the system. Executing the plan 116 typically involves the execution of one or more fundamental database operations, including but not limited to record selection, joins, or sorts. The results 124 of the execution 116 are returned to the user 128.

To handle changing data, the system 100 updates its stored data 120 to reflect the changes in the data, reexecutes 116′ the previously-executed queries 104 against the revised data set 120′, and then returns the results 128′ of reexecution 116′ back to the user. Since each execution is its own independent transaction, the processing time for a request is typically a function of the complexity of the request and the amount of data associated with that request. If real-time results are required, then requests must typically be limited to simple queries when large amounts of data are involved, or there must be some limit imposed on the amount of data, the number of users submitting requests, or the number of applications submitting requests.

These constraints make batch computation poorly suited to real-time processing of large amounts of changing data. Accordingly, there is a need for a system that can perform complex data processing in real-time and can integrate existing databases, data processing, and data delivery systems.

### SUMMARY OF THE INVENTION

The systems and methods of the current invention depart from the use of batch algorithms for organizing, analyzing and generally processing data. Instead, algorithms are employed that work incrementally and can continually process rapidly changing sources of data in real time.

Incremental data processing is made practical by the provision of the following in accord with various embodiments of the present invention: a method of defining and packaging incremental computations; a replication protocol for distributing incremental computations; a system for scheduling concurrent execution of a large number of incremental computations; a method for interacting with batch-mode systems; a scheme for load balancing a directed graph of incremental computations across a distributed set of processors; a scheme for fault-tolerant incremental computation; a scheme for allowing incremental computations to participate in distributed transactions; a scheme for decreasing transaction frequency by aggregating consecutive transactions; and a caching scheme for reducing the random-access memory used by incremental computations.

In one aspect, the present invention relates to a method for data processing. A request is received for execution against a data set. The request is decomposed into at least one incremental computation and, in response to a change in the data set, the at least one incremental computation is executed against the change in the data set. The changes in the data set may include, but are not limited to, an insertion, an update, or a deletion.

One or more of the incremental computations may be assigned for execution to one or more computing resources, such as a server computer or a core in a multicore processor. An assigned incremental computation may itself be replicated to a second computing resource for execution, providing scaling and recoverability. The replicated incremental computation may be synchronized with the original incremental computation, or it may establish communications with the original incremental computation, for example, if communications with the original incremental computation are lost.

In one embodiment, the method further includes the execution of the at least one incremental computation against the data set. The results of executing the at least one incremental computation against the data set, or the change in the data set, may be stored.

In another embodiment, an indicator value is updated upon completion of execution of the incremental computation. A request for a transaction value including an indicator value may be received and, in response to the request, a response may be constructed indicative of the difference between the current state of the incremental computation and the state of the incremental computation associated with the indicator value in the request.

In another aspect, the present invention concerns a method for data processing. A request for execution against a data set is received and the request is decomposed into at least two incremental computations. The first incremental computation is configured to receive an input selected from the group consisting of the data set itself and a second incremental computation. In response to a change in the input, the first incremental computation is executed against the change in the input. Changes in the input include, but are not limited to, an insertion, an update, or a deletion.

The state of the first incremental computation may be set using a transmitted states from the second incremental computation, and the state may be stored prior to executing the first incremental computation against the change in the input. When the state is stored, it may optionally be restored if, for example, the execution against the change in the input is aborted.

In one embodiment, the method further includes providing the result of the execution as an output of the first incremental computation. In other embodiments, the output of the first incremental computation may be an abort message if the execution against the change in the input is aborted.

In still another aspect, the present invention concerns a computer-readable memory having machine-executable instructions including machine-executable instructions for receiving a request for execution against a data set, machine-executable instructions for decomposing the request into at least one incremental computation; and machine-executable instructions for executing the at least one incremental computation against a change in the data set in response to the change in the data set.

In various embodiments, the memory further includes one or more of instructions for providing the current state of the incremental computation, instructions for initializing the incremental computation using the state of another incremental computation, instructions for reverting the state of the incremental computation to an earlier stored state, instructions for transmitting the current state of the incremental computation across a communication channel, instructions for synchronizing the current state of the incremental computation with the state of another incremental computation, and instructions for storing the current state of the incremental computation, for example, using a partially-persistent data structure.

The foregoing and other features and advantages of the present invention will be made more apparent from the description, drawings, and claims that follow.

### BRIEF DESCRIPTION OF DRAWINGS

The advantages of the invention may be better understood by referring to the following drawings taken in conjunction with the accompanying description in which:

FIG. 1 is a block diagram illustrating the operation of a typical prior art relational database;

FIG. 2 presents an example of incremental computation;

FIG. 3A depicts query processing and other computations using an interconnected set of flows in accord with an embodiment of the present invention;

FIG. 3B presents exemplary client and server computers configured in accord with an embodiment of the present invention;

FIG. 4 provides a conceptual diagram of an exemplary flow in accord with the present invention;

FIG. 5 presents a diagram of flow modes and transitions between modes in one embodiment of the present invention;

FIG. 6 illustrates how an epoch thread data structure may be updated in response to data changes in accord with the present invention;

FIG. 7 presents a diagram of one embodiment of a flow scheduler;

FIG. 8 illustrates the locking order of task, task resource, and task queue objects used for flow scheduling;

FIG. 9 is a sequence diagram illustrating how task objects are scheduled;

FIG. 10 is a diagram of one embodiment of a synchronizing mechanism;

FIG. 11 presents an example of the transaction synchronization;

FIG. 12 is a diagram of one embodiment of a merging mechanism; and

FIG. 13 presents one example of correctly merged transactions.

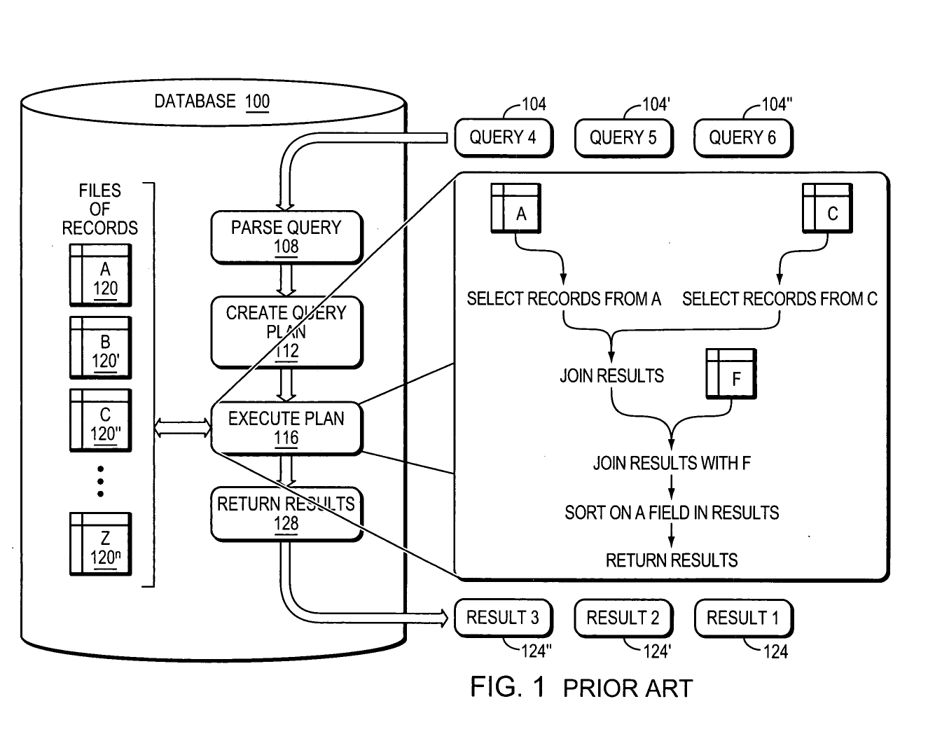

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

The systems and methods of the current invention enable general-purpose processing of large volumes of rapidly changing data in real time. Instead of utilizing batch computing, the present invention solves data processing problems using incremental algorithms. Unlike batch algorithms, incremental algorithms are designed to efficiently update an output solution when changes are made to an input problem.

Embodiments of the inventive system decompose complex or monolithic data processing problems into one or more incremental computations called “flows.” These flows may be distributed across a networked cluster of commodity computers, facilitating scaling and enabling fault-tolerant computing. Embodiments of the present invention are typically designed to be tolerant of unreliable and intermittently available networks (e.g., a wireless network).

Once a request is submitted to an embodiment of the system, the solution to that request may be maintained from that point in time forward, such that whenever changes are made to a problem's data, the solution is efficiently recomputed.

Accordingly, embodiments of the present invention provide several advantages. Rapidly changing data can be processed in real time, such that solutions relating to that data stay current. A wide range of processing functions can be performed, and the scalability provided by the present invention enables the solution of computationally-difficult problems. Scalability also allows for the system to be configured for high-availability or fault-tolerant computing.

Incremental Algorithms

Prior art data processing systems typically use batch algorithms. A batch algorithm starts over each time it is run and does not exploit solutions calculated on previous runs.

The time required by a batch algorithm to produce a solution is typically a function of the size of the input problem. Accordingly, as problems increase in size, batch algorithms require more time to produce solutions. Because of this relationship between the size of the input problem and the time required for its solution, it is usually not possible to frequently run batch algorithms to solve large problems.

Table 1 provides run times for some common batch algorithms used in data processing. Since these algorithms run in linear or low polynomial time, doubling the size of the input, n, will result in at least double the amount of processing for solution.

TABLE 1
Run times for batch algorithms on inputs of size
n, assuming unit processing times for operations.

| Algorithm | Run time |
|---|---|
| min/max on unindexed data | O(n) |
| average | O(n) |
| variance | O(n) |
| sort | O(n log n) |
| simple linear regression | O(n) |
| circuit value annotation problem (spreadsheet | O(n) |
| with n operations) | |
| single-source shortest-path with n vertices and | O(mn) ≈ O(n²) |
| m edges (Bellman-Ford algorithm) | |

By design, batch algorithms have no strategy for efficiently updating the output solution if the input problem is modified. When the input is changed, the batch algorithm must be run again against the input problem in its entirety. Because of this limitation, batch algorithms are typically run periodically and, especially for large n, are typically unable to operate in an event-driven real-time mode.

For example, if averaging n numbers requires 250 milliseconds, then this operation can only be repeated four times per second. Accordingly, averaging twice as many (i.e., 2n) numbers can only be repeated approximately twice a second. If the numbers are changing frequently, e.g., 1,000 times per second, then the batch averaging algorithm simply cannot be rerun against the entire input problem on every change and still provide timely results to an end-user.

One solution to this problem involves the use of incremental algorithms to perform time-sensitive data processing. Unlike batch algorithms, incremental algorithms are designed to efficiently update the output solution when changes are made to the input problem.

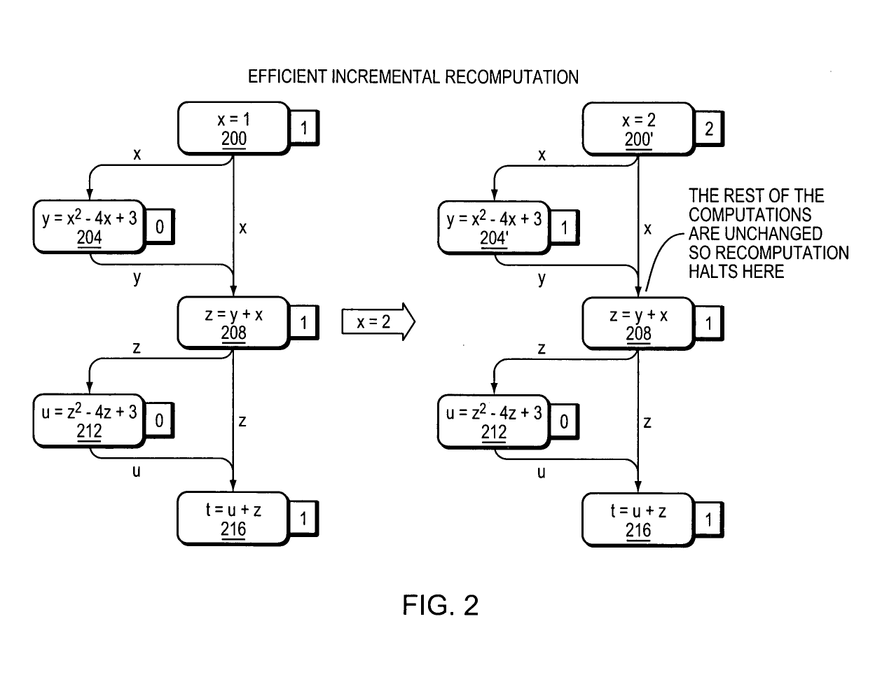

FIG. 2 presents an example of a computation that is incrementally updated in response to a change. The computation begins when x is assigned the value one (Step 200). When x is one, y is equal to zero (Step 204), z is equal to one (Step 208), u is equal to 0 (Step 212), and t is equal to one (Step 216). If x is subsequently assigned the value two (Step 200′) then, following incremental computation, y is equal to negative one (Step 204′) and z remains equal to one (Step 208). Since z remains unchanged, u and t are not recomputed and they retain their respective values (Steps 212, 216).

Incremental algorithms provide at least two advantages relative to batch algorithms. First, if the input problem is large and frequently changes, then an incremental algorithm may be able to maintain the output solution in real time. Second, an incremental algorithm can typically update its output solution with low latency, while the latency of a batch algorithm remains its total run time.

One way to analyze an incremental algorithm is to describe its performance in terms of the size of the original batch input, n, and the size of the changes in the input and the resultant output. For purposes of this discussion, the term ∥δ∥ will be used to represent the size of changes in an algorithm's input and output.

Some batch algorithms, including those focused on data processing, have incremental equivalents. Table 2 lists some incremental algorithms corresponding to the algorithms in Table 1 and their run times in terms of n and ∥δ∥.

TABLE 2
Run times for incremental algorithms to process a
change of size ∥δ∥ on inputs of size n,
assuming unit processing times for operations.

| Algorithm | Run time |
|---|---|
| min/max | O(∥δ∥ log n) |
| Average | O(∥δ∥ log n) |
| Variance | O(∥δ∥ log n) |
| Sort | O(∥δ∥ log n) |
| simple linear regression | O(∥δ∥ log n) |
| circuit value annotation problem (spreadsheet | min(O(2^{∥δ∥}), O(n)) |
| with n operations) | |
| unit changes on single-source shortest-path | O(∥δ∥ log ∥δ∥) |
| with n vertices and m edges | |

As Table 2 suggests, incremental equivalents of batch algorithms are typically more efficient at maintaining an output solution when the input problem changes. For example, if an incrementally sorted set of 1,000,000 numbers can update, insert or remove a number from the set in approximately 5 microseconds, then the set could be updated approximately 200,000 times per second. In comparison, the equivalent batch sort algorithm would take approximately five seconds to sort 1,000,000 randomly generated numbers and roughly 0.875 seconds to resort the set after changing a single number.

Flow Decomposition

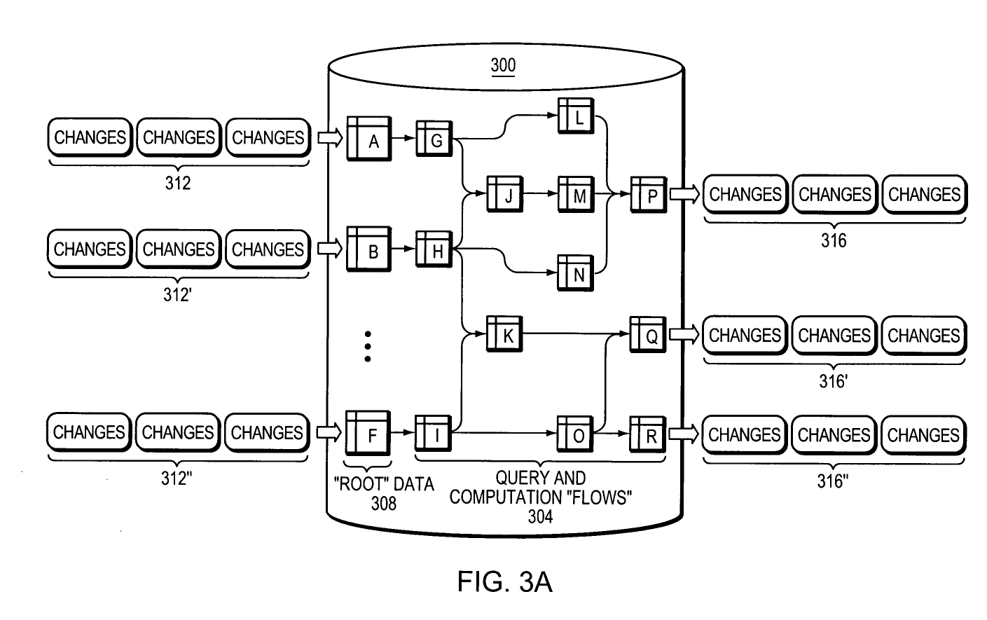

As depicted in FIG. 3A, embodiments of the present invention 300 decompose received requests into sets of incremental computations called “flows” 304. For efficiency, several different requests may share the same component flows, e.g., flows H and O in FIG. 3A. Once decomposed, flows 304 are executed against data sets 308 and the results of execution are provided in response to the requests.

A flow is a discrete software component that continually performs a specific incremental computation. A flow takes, as input, changes to solutions maintained by one or more upstream flows, incrementally processes those changes, and emits changes to its solution downstream. The inputs and outputs of flows can be interconnected, and optionally distributed across a cluster of computers. A collection of flows forms a network capable of complex, continual processing of data.

FIG. 3B illustrates the layers of software present in a typical embodiment of the present invention. The top stack illustrates the parts of the system that a minimal client uses to make a copy of data from one or more servers in the system. Utilizing this software, the client replicates flows of interest and maintains them automatically. The client scripting language and presentation nodes allow applications to observe and present changes to the replicated flow.

The bottom stack presents a typical embodiment of a server computer in accord with the present invention. The server receives external data feeds (finance, sports, news, etc), and includes replicated flows, a module to locate flows by name or other metadata, a module to manage the replication and distribution of flows, and a stable storage service that atomically and durably writes data to persistent offline storage.

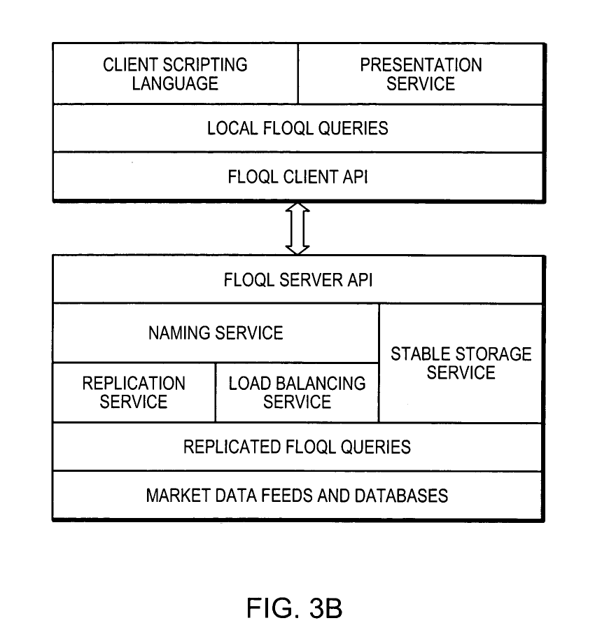

With reference to FIG. 4, an example flow 400 takes as input changes to solutions a, b, and c from one or more upstream flows. The flow 400 incrementally processes inputs a, b, and c, optionally utilizing auxiliary data 404, and emits its result set based on those changes downstream as output d 408.

Returning to FIG. 2, in accord with the present invention a flow 204 is designed to incrementally and continually maintain a solution to a particular type of problem or request. Individual flows may in turn be connected together such that the solutions of one or more “upstream” flows are used as inputs to a “downstream” flow. For example, FIG. 2 depicts upstream flows O and K feeding into downstream flow Q. Upstream changes 212 to the input data set 208 effectively propagate downstream through the series of interconnected flows and result in changes 216 to the previous results from a particular problem or query. Each time a transaction in a flow is completed and committed, the flow's epoch number is incremented. Assuming the presence of inter-flow communications, the epoch numbers for a flow and its fully synchronized replicas are typically the same.

Typical incremental computations implemented by a flow include relational database-like functions (selects, joints, aggregations, reindexing, partition, etc.); statistical functions (count, sum, average, variance, min/max); analytics (simple linear regression, multivariate linear regression, pairwise covariance, pairwise similarity); convolutional operators (moving average, exponential moving average, generalized convolution functions); general-purpose spreadsheet environments; data visualization tools; and interaction with external systems. Particular flows may be provided in a library for use, and may be modified at compile time or run-time.

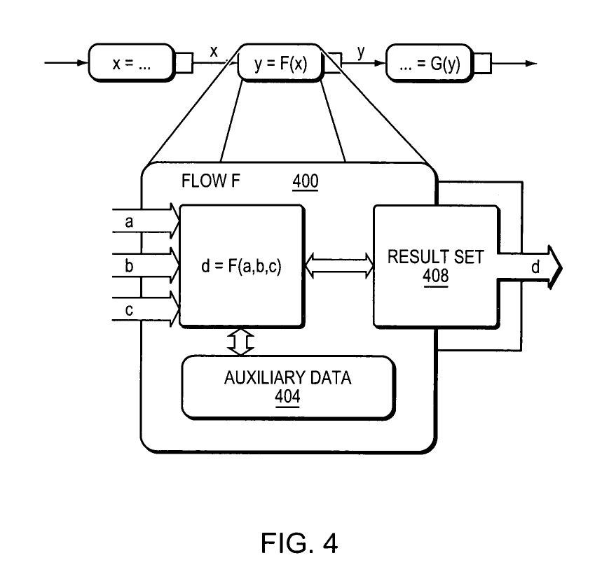

In one embodiment of the present invention, a flow operates in one of four states: off-line, initializing, on-line, and recovering. With reference to FIG. 5, a newly-created flow begins in the off-line state 500, after it has been created but before it is initialized. Once created, the flow is either initialized using snapshots from upstream flows 504 or through replication of an existing flow 504′. Once initialized 504 the flow operates in on-line mode 508, where it receives changes from one or more upstream flows, performs its incremental computation, and provides output changes downstream. If, for example, communications are lost between a flow and its original flow or a replica flow, then the flow enters the recovering state 512 where it synchronizes its state with the state of another process, e.g., the original flow or a replica flow. Once synchronization is complete, the flow returns to the on-line state 508 for normal operations.

In addition to providing incremental computation functionality, in further embodiments a flow also includes functionality: (1) to produce a snapshot of the current solution to its incremental computation; (2) to itself be initialized with snapshots from one or more upstream flows; (3) to process changes transactionally, such that changes within a transaction are processed speculatively and are undone if the transaction is aborted; (4) to replicate itself across a communication channel (e.g., an unreliable channel) to a remote process; and (5) to synchronize itself with another flow (such as after a communications failure of any duration).

These additional functionalities may themselves be interdependent. Functionality that replicates a flow may itself rely on functionality that produces a snapshot of the flow to be replicated. Likewise, functionality that allows initialization from upstream snapshots itself relies on the ability of the upstream flows to produce snapshots. Processing transactions speculatively may be implemented by producing a snapshot of the current solution to the incremental computation, storing the snapshot in a persistent memory, and then recalling the snapshot should the transaction be aborted.

These additional functionalities may be provided to developers in the form of, e.g., a software library of instantiable objects, such that a developer may add new incremental flows without understanding how these additional functionalities are actually implemented.

Details of Flow Functionality

As described above, a flow may include functionality to produce an instantaneous copy, i.e., a “snapshot,” of its current result set. Utilizing system memory, a snapshot may be stored indefinitely with little impact on system performance. Exemplary uses for these snapshots include backing out of aborted transactions; initializing downstream flows; and checkpointing the state of a flow's result set for reporting, archiving, or other purposes.

In one embodiment of the present invention, the ability to produce snapshots in a computationally inexpensive manner is realized by using a partially persistent data structure. Normally when an update is made to an imperative (i.e., ephemeral) data structure the existing data is updated in place and destroyed. Partially persistent data structures do not destroy existing data when an update is made. Instead, the existing version of the data is saved and a new version containing the update is created. Furthermore, an effort is made to share any data that is common between the old and new versions, thus achieving some measure of efficiency.

A flow may also include functionality to initialize itself using snapshots from one or more upstream flows. In one embodiment, a flow first obtains snapshots of all upstream flows and ensures that all post-snapshot input changes will be captured. Using the snapshots, the flow is initialized and the snapshots may then subsequently be discarded. Once initialized, the flow shifts to online mode and begins processing incremental changes emitted by the upstream flows. To obtain a snapshot from a flow that can be processing a transaction and at the same time ensure that all succeeding changes will be captured requires coordination with the flow's transactional interface.

Transactions and Changes

As discussed above, a flow incrementally recomputes its solution in response to upstream changes. If the input problem is represented by a set of values, then a change event may be defined to be either an insertion of a new value, an update of an existing value, or a deletion of an existing value. The stream of changes itself comprises a series of transactions, with each transaction containing an ordered set of change events. For purposes of this discussion, a transaction is defined as an ordered sequence of changes that are applied to a flow's input problem in its entirety or not at all.

In a tree of interconnected flows, a transaction propagates from the root of the tree to its leaves. The beginning of the transaction quickly moves toward the leaves and the end of the transaction follows as quickly as the intermediate flows can process the changes. If any one flow aborts the transaction, then all of the flows in the subtree relative to the aborting flow will also abort their transactions.

One embodiment of the present invention provides a novel approach to performing transactions on an acyclic graph of computations. A set of change events enclosed in a transaction is streamed to a flow starting with a “start transaction” event and ending with an “end transaction” event. Processing begins immediately and proceeds speculatively until an “end transaction” event is received and the changes to the flow's solution are committed. If an “abort transaction” event is received or there is a communications failure, then all uncommitted changes are undone and the transaction is aborted.

Enclosing sets of changes within transaction boundaries as described provides several advantages. First, when a flow completes processing of a transaction of changes, the flow is in a stable state and is ready for the creation of snapshots. Second, transaction processing can proceed speculatively and safely in the presence of errors. Third, allowing a transaction to proceed before the end of the transaction is reached reduces computational latency; as noted above, if the transaction is aborted the transaction is also aborted in all downstream flows.

In a further embodiment, multiple transactions may be merged into a single transaction by collapsing certain change event sequences into shorter sequences. For example, an insert event in one transaction followed by a delete event in a subsequent transaction would, post merge, result in no event at all. Collapsing change event sequences may result in bandwidth savings, memory savings, and an avoidance of the need to move a particular flow into recovery mode.

Replication and Clustering

Utilizing the aforementioned replication functionality, flows may be efficiently replicated across reliable or unreliable communication channels, including LANs, WANs and other networks. Once a flow has been replicated to a remote processor, it can continue to be incrementally synchronized. Incremental synchronization can occur using a generic protocol such as HTTP, or using a replication protocol tailored for bandwidth efficiency and continual flow replication. If and when a channel fails between an original flow and its replicated flow, the replicated flow can simply reconnect to its original flow, or another flow replicating the original flow, and synchronize states before continuing processing.

Utilizing flow replication capabilities permits the distribution of flows across a networked plurality of computing elements, such as server computers or multicore processors. Replication across computing elements allows for the aggregation of computational power and in-memory storage, permitting the system to scale for the solution of large or difficult requests. Embodiments of the present invention are typically designed to be tolerant of unreliable and intermittently available networks (e.g., a wireless network).

The replication of flows across computing resources also allows for fault-tolerant computations in embodiments of the present invention. For example, a set of flows executing on a single computer may be replicated on several other computers. If the original computer or any of its replicas fails, the remaining replicas can continue execution and communication with other (e.g., downstream) flows. Embodiments of the present invention may preempt system crashes by ensuring that multiple replicas of a flow are distributed throughout a computing cluster. The system's resiliency—the number of failures that can be withstood—determines the number of replicas that are maintained for each flow.

Each process in a cluster may contain a large number of flows, but typically only the leaf flows in the process are replicated for distribution to other servers. A leaf flow is any flow in an acyclic, directed graph of interconnected flows that is a leaf in the flow graph's forest of trees. In contrast, a root flow is any flow that is a root in the flow graph's forest of trees. A root flow is necessarily a replica of a leaf flow from another process. A flow that is neither a root nor a leaf is an internal flow.

As a transaction propagates from a leaf flow to its replicas, the transaction is normally processed speculatively. However, when the transaction is committed at the primary flow, a majority of replicas typically must also acknowledge that their transaction copy was also committed.

When a crash occurs, all of the flows in the failed process are typically lost. However, due to the aforementioned replication policy, there typically exist replicas of the leaf flows that survived those that expired in the failed process. In order to restore the crashed process and its flows, first either a new process is created or an existing process is selected that has enough resources to support the recreation of all the lost flows. For each root and leaf flow that was in the failed process, a current flow replica is located and is in turn replicated to the new process. Using the root and leaf flows, the internal flows are recomputed and then all of the flows are connected and resynchronized.

Flow processing scalability is achieved by distributing flows over a cluster of servers using a robust replication protocol. A collection of interconnected flows may require more resources than are available on a single server. Distributing the flows' workload across a collection of servers is the solution provided that the distribution scheme properly addresses computing resource or network failures.

Accordingly, one embodiment of the present invention provides a flow replication protocol having the following capabilities: (1) efficiently transmitting sets of changes enclosed in transactions to a remote process; (2) merging and compacting successive transactions before processing by a flow; and (3) efficiently synchronizing a flow replica after a communications failure of any duration.

If a communications failure occurs and transactions are not delivered from an original flow to a replica flow, then the replica flow must be synchronized with another more current replica or the original flow when communications are restored. This synchronization process is handled by a recovery protocol. In one embodiment, the recovery protocol sends only the minimum number of messages needed to synchronize the out-of-sync replica. This capability allows a flow to be disconnected for any duration and then be successfully synchronized with its replica.

In one embodiment, the recovery protocol relies on an “epoch thread,” a space-efficient data structure that, when given the epoch number of an out-of-sync flow replica, returns a series of messages that will synchronize the out-of-sync replica with the later epoch replica.

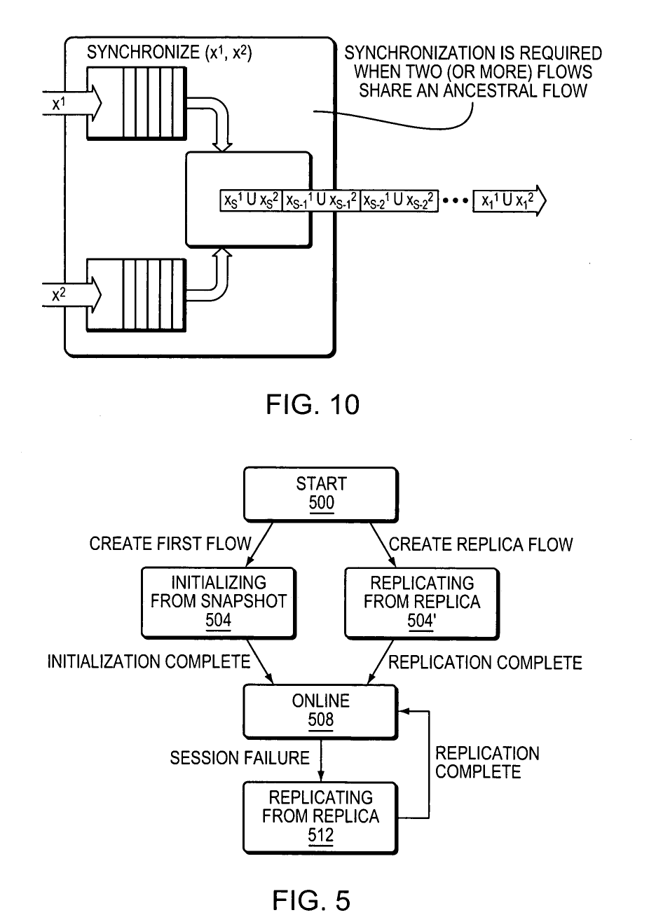

The epoch thread data structure maintains two chronologically ordered sets: one containing a flow solution's values and “gaps,” i.e., a data structure that compactly represents deleted values, and one of only gaps. Whenever a value is inserted or updated, but not deleted, the value is moved to the end of the epoch thread's values and gaps list and the epoch number of the flow is incremented. If a value is deleted from the flow's solution set, then a gap record replaces the deleted value in the values and gaps list, an additional reference to the newly created gap is moved to the end of the gaps-only list, and the epoch number is incremented by two. Adjacent gap records in the values and gaps list are merged whenever possible. In one embodiment, the values and gaps in the value and gap and gap-only lists are ordered chronologically by the epoch they were modified. FIG. 6 presents an example of an epoch thread data structure changed by inserts, updates, and deletion.

Given two epoch thread structures, one being of an older epoch than the other, the older epoch thread can synchronize with the newer epoch thread and generate the series of insert, update and deletion events needed to complete the synchronization between thread structures. Similarly, as an out-of-sync flow recovers, it incrementally updates its solution and emits changes downstream. All of the changes induced by the recovery process are enclosed in a transaction. A flow remains in the recovering state until it is fully synchronized with its replica.

In a further embodiment, a modified epoch thread structure writes rarely modified values to secondary storage and thereby reduces the flow's memory requirement. Only the temporally newest and the most frequently modified values will be cached in memory while the remaining values exist in secondary storage. This takes advantage of flows that contain large numbers of values that are infrequently updated or deleted, which itself may be detected during a run-time inspection of the flow's epoch thread structure.

Flow Scheduling and Synchronization

Each computer implementing the flows of the present invention typically must schedule the concurrent execution of a very large number of fine-grained incremental computations. Each of these incremental computations in turn process changes to their input problems and output changes to their solutions to potentially a very large number of other incremental computations. Accordingly, efficient load scheduling under these conditions requires a concurrency mechanism with low resource usage and high scalability that also makes full use of multiprocessor systems.

In one embodiment, operating system threads are utilized as one mechanism for concurrency. In another embodiment, the system uses a hybrid event-driven and threaded concurrency framework to manage execution, initialization and recovery of flows.

In this latter embodiment, three mechanisms make up the concurrency framework: tasks, task resources and task queues. A task performs work and is associated with a task resource and a task queue. The task resource handles notifications of work, and the task queue executes tasks. When a task resource is notified, all waiting tasks associated with the resource are added to task's associated task queue. A task queue can coexist with single-threaded concurrency schemes, like in a graphical user interface, or harness multiple processors by using multiple threads to process tasks that are ready for execution.

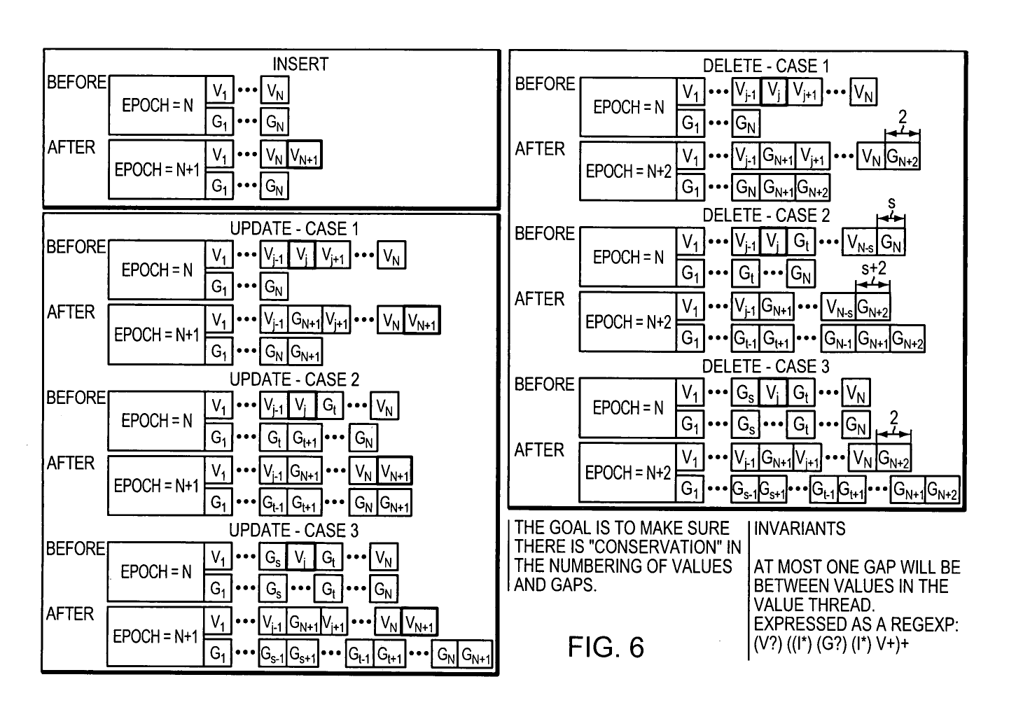

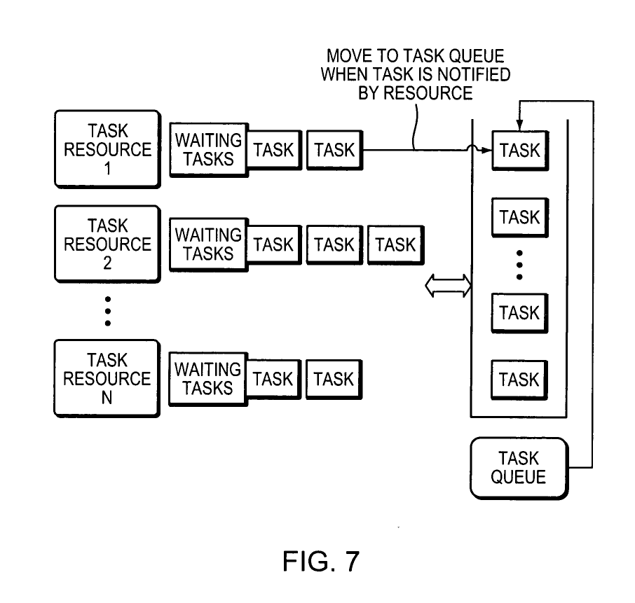

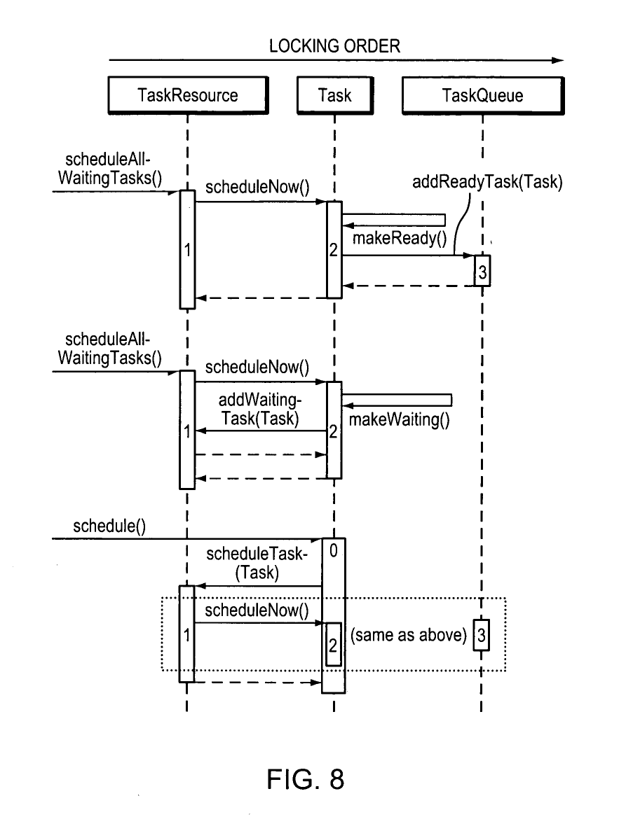

FIG. 7 presents a typical server implementation in accord with the present invention that achieves a high level of concurrency without using an excessive number of operating system resources. This is accomplished by performing scheduling and execution in a fine-grained manner in the application instead of relying on operating system threads, processes, and other resources. The implementation of scheduling and execution in the application is optional, and it may be implemented in reliance on operating system threads, processes, and other resources in other embodiments. Likewise, FIG. 8 demonstrates how locking is performed in a lightweight scheduler/executor in one embodiment of the present invention, and FIG. 9 shows how data passes between flows and how concurrency and locking are performed in another embodiment of the present invention.

As discussed in previous sections, changes propagate quickly through the network of flows as each flow processes its input changes. If two or more flows are used as inputs to another flow then a special mechanism must be used either to merge or synchronize the inputs into a single flow input.

If two or more series of flows that have flows in common are used as inputs to the same flow, then their transactions must be synchronized. The synchronization begins with each transaction being assigned a source ID and a transaction ID. Transactions may contain more than one source ID and transaction ID pair, but this typically will only happen during a flow recovery.

A source flow is a flow that is a “root” in the directed graph of interconnected flows. Transactions emanating from the same source flow have the same source ID. Consecutive transactions emanating from the same source flow have transaction IDs that are strictly increasing.

A synchronizer matches source IDs and transaction IDs among flow inputs. One or more transactions are in conflict, for example, if their source IDs match and their transaction IDs do not. If any arriving transactions are in conflict, the synchronizer will merge transactions (as discussed below), until an arriving transaction resolves the conflict. If a transaction or merged set of transactions is not in conflict, then it is simply forwarded to the flow for processing.

One example requiring synchronization concerns “jitter” in computations. Assume a flow A that is an input to two other flows, B and C. Each flow B and C performs a different analysis on the values in the result set of A. Now assume flow D performs an analysis based on the outputs of both flows B and C. If the results of flows B and C are not synchronized, then changing outputs from B and C deriving from the same initial transaction of changes might arrive at flow D at different times. If transactions with the same transaction ID were allowed to arrive at different times then a flow would either have to compensate for the differential in arrival times or accept “inaccurate” computations.

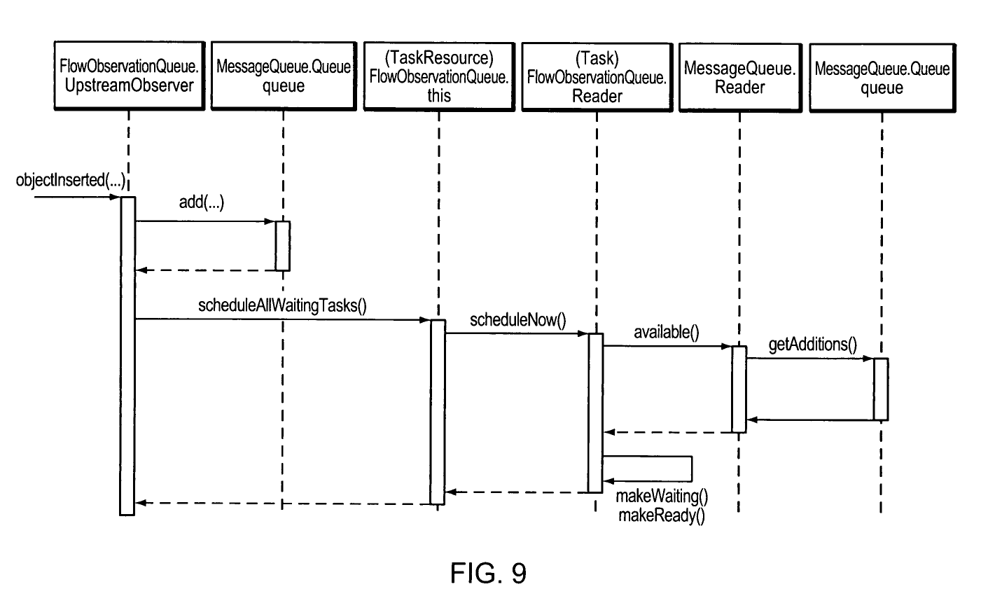

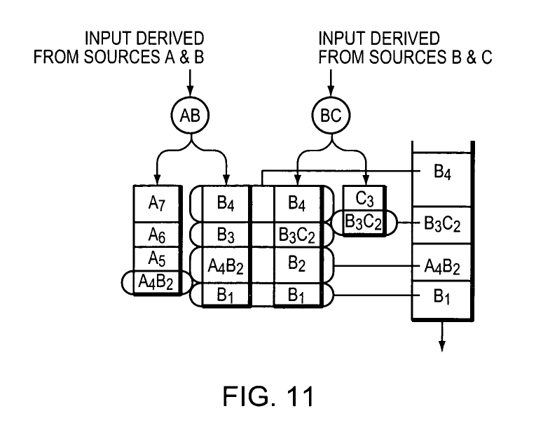

FIGS. 10 and 11 present examples of synchronizer mechanisms. These figures show how transactions that proceed through different flow paths before rejoining are synchronized and combined again. This is typically required when data flows pass through the system asynchronously and transactions can therefore proceed through different flow paths at different speeds. The synchronization and merge flows are primitives that recombine transactions with the same number into one transaction and in increasing order.

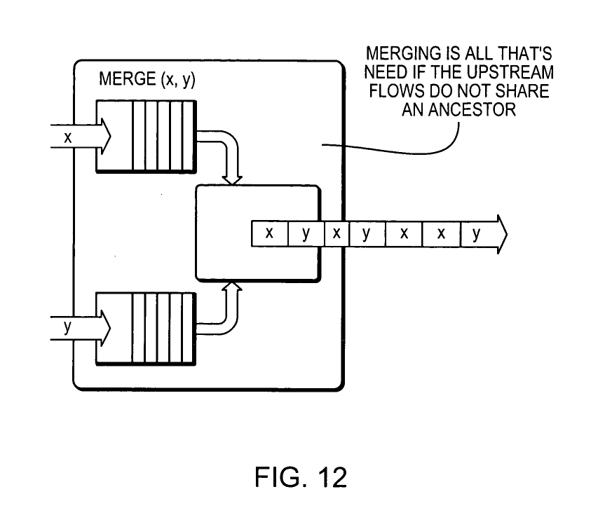

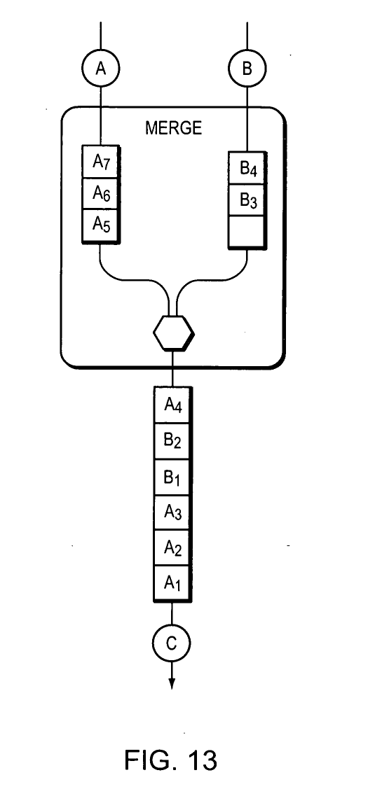

If two or more series of flows have no flows in common, then completed transactions are forwarded on a simple first-completed/first-emitted basis. This is handled by a merge mechanism, as illustrated in FIGS. 12 and 13.

Applications

Embodiments of the present invention provide a general-purpose platform for processing data in real time and therefore have many potential applications. Broadly speaking, embodiments of the present invention may be used to either replace or accelerate relational queries and other general computations.

The ability to generate snapshots of a flow's current solution allows embodiments of the present invention to operate as a batch-mode system, even though the underlying flows perform incremental computing tasks. For example, when a request is made for the results of a flow, an instantaneous snapshot of the flow's solution is created and returned. While the snapshot is held in memory, the flow at issue and the remaining flows can continue processing changes to the input problem without interruption. Once used, the snapshot can be disposed at any time.

Snapshot functionality also allows conventional batch processing systems that cannot operate in an incremental or event-driven mode to interact with embodiments of the present invention. For example, a “database adapter” is a piece of software that translates a generalized set of database commands into specific commands used by a particular database vendor. A database adapter written for an embodiment of the present invention would allow applications like report generators to interact with the real-time solutions continually being generated by flows in the system. Such an adapter would obtain a snapshot of a flow's solution, apply generalized commands to the snapshot, return the result, and dispose of the snapshot.

The ability to create a replica of a flow in another process, possibly on another machine, allows flows to be migrated. When a flow is migrated it is moved from one process to another. Migration is accomplished by replicating the original flow to a remote process, and when the replication is completed, the original flow is disposed. Flow migration allows for the exploitation of unused computing resources (memory, computational power, bandwidth, etc.), a reduction in the overutilization of resources in the original process, a reduction in inter-flow communications latency by migrating a flow closer to interconnected flows or replicas, and to allow for the graceful termination of a process.

The application of a load balancing algorithm in conjunction with flow migration will attempt to create a near-optimal assignment of flows to processes. The algorithm will first observe the amount of memory, computation, and communications latency and bandwidth consumed by each flow. This data may then be used to estimate future resource demands for each flow. The resource demands estimates, as well as the cost of migrating an existing flow, may be used to periodically reassign flows to processes in a computing cluster.

Embodiments of the present invention may also participate in distributed transactions. A distributed transaction coordinator orchestrates transactions involving multiple transaction processing systems like databases, message queues, and application servers. An embodiment of the present invention may integrate with other transaction processing systems by, for example, implementing an industry-standard distributed transaction interface.

In the financial services industry, embodiments of the present invention may be used to provide program trading and other real-time or near-time trading applications; back-office trade processing (e.g., real-time processing and accounting of positions, profit & loss, settlements, inventory, and risk measures); the identification of arbitrage opportunities (price differences between an exchange traded fund and its equivalent future; option combinations; mispriced options, convertibles, exchange traded funds, futures, equity notes, etc.); risk management (monitoring positions and trends); margin management; compliance (e.g., trading statistics and audit trail reports); employee performance; real-time reconciliation, and enterprise-wide alert generation.

Other applications exist in the telecommunications industry (e.g., real-time billing, soft message switching); transportation logistics (real-time fusion and visualization of demands, supplies, locations, schedules and forecasts); inventory and supply chain management (e.g., point-of-sale applications and dynamic pricing); customer relationship management (for example, real-time profiling of customer data); fraud detection; general content management and distribution (e.g., “digital dashboard” applications, streaming data feeds, etc.); and messaging middleware.

It will therefore be seen that the foregoing represents a highly advantageous approach to the processing of changing data sets. The terms and expressions employed herein are used as terms of description and not of limitation and there is no intention, in the use of such terms and expressions, of excluding any equivalents of the features shown and described or portions thereof, but it is recognized that various modifications are possible within the scope of the invention claimed.

Therefore, it must be expressly understood that the illustrated embodiments have been shown only for the purposes of example and should not be taken as limiting the invention, which is defined by the following claims. The following claims are thus to be read as not only literally including what is set forth by the claims but also to include all equivalents that are insubstantially different, even though not identical in other respects to what is shown and described in the above illustrations.

What is claimed is:

1. A method for data processing, the method comprising:
receiving a request for execution against a data set;
decomposing the request into at least one incremental computation; and
in response to a change in the data set, executing the at least one incremental computation against the change in the data set.

2. The method of claim 1 further comprising executing the at least one incremental computation against the data set.

3. The method of claim 2 further comprising storing the result of executing the at least one incremental computation against the data set.

4. The method of claim 1 further comprising storing the result of executing the at least one incremental computation against the change in the data set.

5. The method of claim 1 further comprising assigning at least one of the at least one incremental computation to a computing resource for execution.

6. The method of claim 5 wherein the computing resource is a server computer.

7. The method of claim 5 wherein the computing resource is a core in a multicore processor.

8. The method of claim 1 further comprising replicating an assigned incremental computation to a second computing resource for execution.

9. The method of claim 8 further comprising synchronizing the replicated incremental computation with the original incremental computation.

10. The method of claim 9 further comprising establishing communications between the replicated incremental computation and the original incremental computation.

11. The method of claim 8 further comprising establishing communications with the replicated incremental computation in response to a loss of communications with the original incremental computation.

12. The method of claim 1 wherein the change in the data set is selected from the group consisting of an insertion, an update, or a deletion.

13. The method of claim 1 further comprising updating an indicator value upon completion of execution of the incremental computation.

14. The method of claim 1 further comprising:
receiving a request for a transaction history including an indicator value;
constructing a response to the request indicating the difference between the current state of the incremental computation and the state of the incremental computation associated with the indicator value.

15. A method for data processing, the method comprising:
receiving a request for execution against a data set;
decomposing the request into at least two incremental computations;
configuring the first incremental computation to receive an input selected from the group consisting of the data set and a second incremental computation; and
in response to a change in the input, executing the first incremental computation against the change in the input.

16. The method of claim 15 further comprising providing the result of the execution as an output of the first incremental computation.

17. The method of claim 16 further comprising providing an abort message as an output of the first incremental computation if the execution against the change in the input is aborted.

18. The method of claim 15 further comprising setting the state of the first incremental computation using a transmitted state from the second incremental computation.

19. The method of claim 15 further comprising storing the state of the first incremental computation prior to executing the first incremental computation against the change in the input.

20. The method of claim 19 further comprising restoring the stored state of the first incremental computation if the execution against the change in the input is aborted.

21. The method of claim 15 wherein the change in the input is selected from the group consisting of an insertion, an update, or a deletion.

22. A computer-readable memory comprising machine-executable instructions, the machine-executable instructions comprising:
instructions for receiving a request for execution against a data set;
instructions for decomposing the request into at least one incremental computation; and
instructions for executing the at least one incremental computation against a change in the data set in response to the change in the data set.

23. The memory of claim 22, the instructions further comprising instructions for providing the current state of the incremental computation.

24. The memory of claim 23, the instructions further comprising instructions for storing the current state of the incremental computation.

25. The memory of claim 24, wherein the instructions for storing the current state of the incremental computation utilize a partially-persistent data structure.

26. The memory of claim 21, the instructions further comprising instructions for initializing the incremental computation using the state of another incremental computation.

27. The memory of claim 21, the instructions further comprising instructions for reverting the state of the incremental computation to an earlier stored state.

28. The memory of claim 21, the instructions further comprising instructions for transmitting the current state of the incremental computation across a communication channel.

29. The memory of claim 21, the instructions further comprising instructions for synchronizing the current state of the incremental computation with the state of another incremental computation.
